(19) United States
(12) Patent Application Publication
(10) Pub. No.: US 2023/0093034 A1
(43) Pub. Date: Mar. 23, 2023

(54) TARGET AREA DETECTION DEVICE, TARGET AREA DETECTION METHOD, AND TARGET AREA DETECTION PROGRAM

(71) Applicant: NIPPON TELEGRAPH AND TELEPHONE CORPORATION, Tokyo (JP)

(72) Inventors: Shingo ANDO, Tokyo (JP); Tomohiko OSADA, Tokyo (JP); Kazuhiko MURASAKI, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 17/802,081

(22) PCT Filed: Feb. 26, 2020
(86) PCT No.: PCT/JP2020/007657

§ 371 Date: Aug. 24, 2022

(51) Int. Cl. G06V 10/774; G06T 7/00; G06T 7/70; G06V 10/22; G06V 10/36

(52) U.S. Cl. CPC G06V 10/774; G06T 7/0002; G06T 7/70; G06V 10/22; G06V 10/36; G06T 2207/20081; G06T 2207/20021; G06T 2207/20084

(57) ABSTRACT

A candidate detection unit 118 detects, for each of a plurality of target images, candidate regions representing a specific detection target region using a discriminator. A region-label acquisition unit 120 acquires, for a part of the target images, position information of a search region as a teacher label. A region specifying unit 121 imparts, based on the part of the target images and the acquired position information of the search region, the position information of the search region to each of the target images, which are not the part of the target images, in semi-supervised learning processing. A filtering unit 122 outputs, for each of the acquired plurality of target images, among the candidate regions, a candidate region, an overlapping degree of which with the search region is equal to or larger than a fixed threshold.

### TECHNICAL FIELD

A technique of the present disclosure relates to a target region detection device, a target region detection method, and a target region detection program.

### BACKGROUND ART

According to the ability improvement of a computer and the development of a machine learning technology, deterioration events of various structures have been able to be detected automatically using various camera images. Automatic detection of a specific deterioration event such as a crack has been reaching a practical level in recent years. Under such a situation, it has been examined whether a deterioration event, for which visual determination is difficult, can be more accurately detected by using an image photographed by optical equipment other than a visible light camera. For example, Patent Literature 1 proposes means for more accurately automatically estimating a rust corrosion degree of a conduit or the like based on a hyper spectrum camera image.

### CITATION LIST

### Patent Literature

Patent Literature 1: Japanese Patent Laid-Open No. 2019-144099

### SUMMARY OF THE INVENTION

### Technical Problem

However, for example, for detection of “loose scale” considered to be visually recognizable by an infrared camera, since the “loose scale” clearly has a weaker signal than other noise present in the background and has an extremely variety of shape patterns, it is still difficult to reach detection accuracy meeting practical use even with the latest machine learning technology such as deep learning. In special cameras such as the hyper spectrum camera and the infrared camera, since the number of channels is large and a dynamic range is excessively wide, for visual confirmation, search has to be performed while adjusting many parameters and repeating imaging. In a building wall surface inspection in recent years, a wall surface of one building is comprehensibly photographed from various positions and directions using a drone and photographed images are inspected one by one to specify deteriorated parts. However, in this work, several thousand to several ten thousand images have to be visually confirmed. Under the current situation, an enormous time is required to search through all the images with the confirmation method explained above. If this work time can be reduced by prior screening, considerable work efficiency can be expected.

A technique of the disclosure has been devised in view of the points described above, and an object of the disclosure is to provide a target region detection device, a target region detection method, and a target region detection program that can detect a specific detection target region from a plurality of target images with simple processing.

### Means for Solving the Problem

A first aspect of the present disclosure is a target region detection device including: a target-image acquisition unit that acquires a plurality of target images set as targets for detecting a specific detection target region; a candidate detection unit that detects, for each of the acquired plurality of target images, from the target image, candidate regions representing the specific detection target region using a pre-learned discriminator for discriminating the specific detection target region; a region-label acquisition unit that acquires, for a part of the acquired plurality of target images, position information of a search region in the target image as a teacher label; a region specifying unit that imparts, based on the part of the target images and the position information of the search region acquired by the region-label acquisition unit, the position information of the search region to each of the target images, which are not the part of the target images, among the acquired plurality of target images in semi-supervised learning processing; and a filtering unit that performs, for each of the acquired plurality of target images, filtering processing for outputting, from the candidate regions detected by the candidate detection unit, a candidate region, an overlapping degree of which with the search region is equal to or larger than a fixed threshold.

A second aspect of the present disclosure is a target region detection method including: a target-image acquisition unit acquiring a plurality of target images set as targets for detecting a specific detection target region; a candidate detection unit detecting, for each of the acquired plurality of target images, from the target image, candidate regions representing the specific detection target region using a pre-learned discriminator for discriminating the specific detection target region; a region-label acquisition unit acquiring, for a part of the acquired plurality of target images, position information of a search region in the target image as a teacher label; a region specifying unit imparting, based on the part of the target images and the position information of the search region acquired by the region-label acquisition unit, the position information of the search region to each of the target images, which are not the part of the target images, among the acquired plurality of target images in semi-supervised learning processing; and a filtering unit performing, for each of the acquired plurality of target images, filtering processing for outputting, from the candidate regions detected by the candidate detection unit, a candidate region, an overlapping degree of which with the search region is equal to or larger than a fixed threshold.

A third aspect of the present disclosure is a target region detection program for causing a computer to execute: acquiring a plurality of target images set as targets for detecting a specific detection target region; detecting, for each of the acquired plurality of target images, from the target image, candidate regions representing the specific detection target region using a pre-learned discriminator for discriminating the specific detection target region; acquiring, for a part of the acquired plurality of target images, position information of a search region in the target image as a teacher label; imparting, based on the part of the target images and the acquired position information of the search region, the position information of the search region to each of the target images, which are not the part of the target images, among the acquired plurality of target images in semi-supervised learning processing; and performing, for each of the acquired plurality of target images, filtering processing for outputting, from the detected candidate regions, a candidate region, an overlapping degree of which with the search region is equal to or larger than a fixed threshold.

### Effects of the Invention

According to the technique of the disclosure, it is possible to detect a specific detection target region from a plurality of target images with simple processing.

### BRIEF DESCRIPTION OF DRAWINGS

FIG. 1 is an image diagram for explaining a deterioration region.

FIG. 2 is an image diagram for explaining segmented images of a search region.

FIG. 3 is an image diagram for explaining a search region given as a teacher label.

FIG. 4 is an image diagram for explaining a specified search region.

FIG. 5 is an image diagram for explaining filtering of candidate regions.

FIG. 6 is a schematic block diagram of an example of a computer functioning as a learning device and a target region detection device in an embodiment.

FIG. 7 is a block diagram showing a functional configuration of the learning device in the embodiment.

FIG. 8 is a diagram showing an example of an input and output curve.

FIG. 9 is a block diagram showing a functional configuration of the target region detection device in the embodiment.

FIG. 10 is a diagram showing an example of a plurality of kinds of input and output curves.

FIG. 11 is a flowchart showing a flow of learning processing in the embodiment.

FIG. 12 is a flowchart showing a flow of target region detection processing in the embodiment.

### DESCRIPTION OF EMBODIMENTS

An example of an embodiment of a technique of the disclosure is explained below with reference to the drawings. Note that, in the drawings, the same or equivalent components and portions are denoted by the same reference numerals and signs. Dimension ratios of the drawings are exaggerated for convenience of explanation and are sometimes different from actual ratios.

### Overview of this Embodiment

This embodiment provides means capable of highly accurately automatically detecting a deterioration region having an extremely low S/N ratio and a variety of shape patterns represented by “loose scale”.

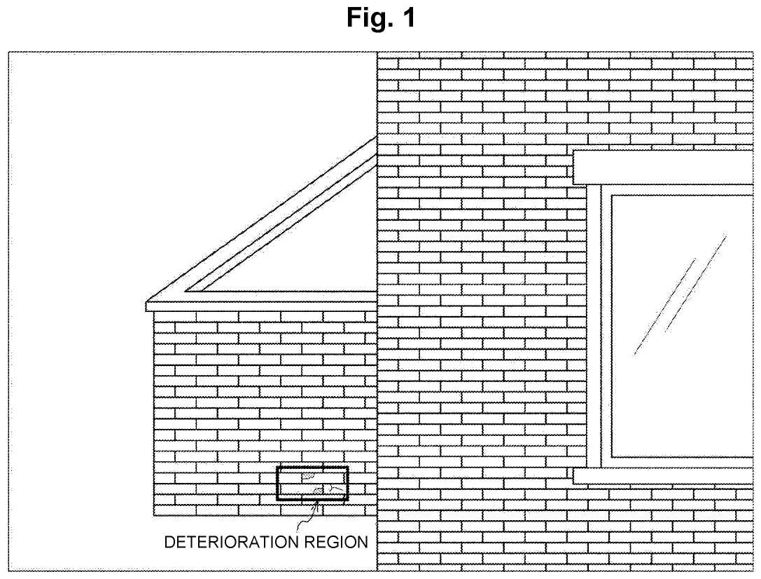

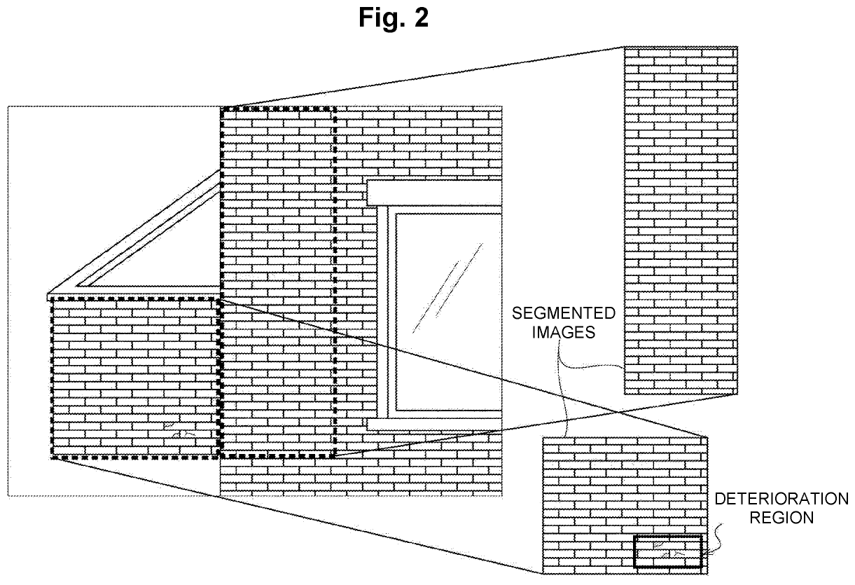

Image data photographed using various cameras including special optical equipment such as an infrared camera is received as an input. First, learning processing is performed based on a collected plurality of images representing a deterioration region. In a learning process, about an image obtained by photographing deterioration events of various buildings, a human imparts, as a teacher label, a rectangular region or a region surrounded by a free form indicating where in the image deterioration regions representing the deterioration events are included. The teacher label and the image representing the deterioration region are linked (FIG. 1). Thereafter, an image is segmented such that only a specific part where a deterioration event set as a target could occur is included as a background and the image is set as an image for learning (FIG. 2). For example, in the loose scale, an intra-image region where a “wall surface tile” or the like is imaged corresponds to the specific part where a deterioration event could occur. In the following explanation, the specific part is uniformly referred to as “search region”. A generally known method such as Mask R-CNN only has to be used for a discriminator for discriminating the deterioration region.

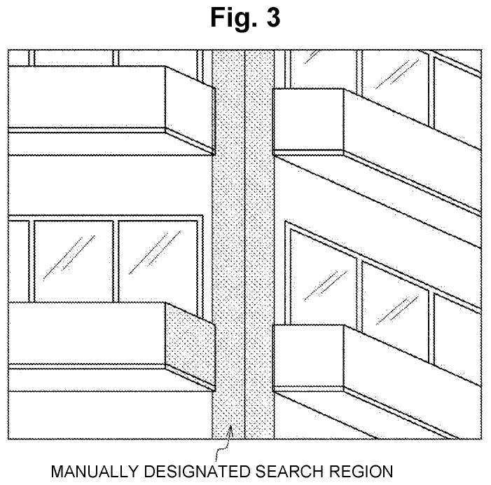

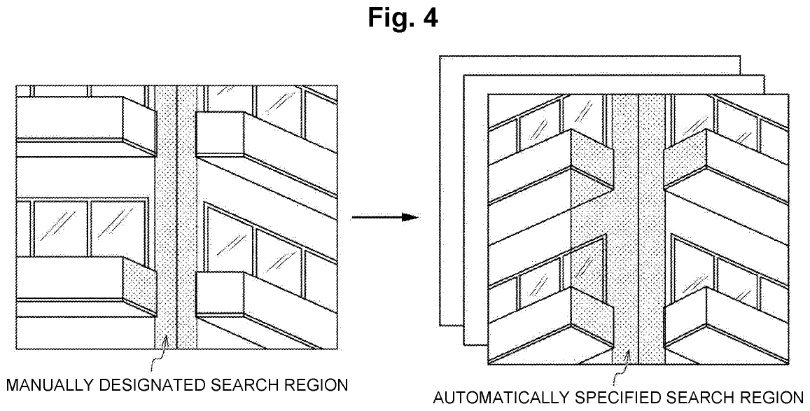

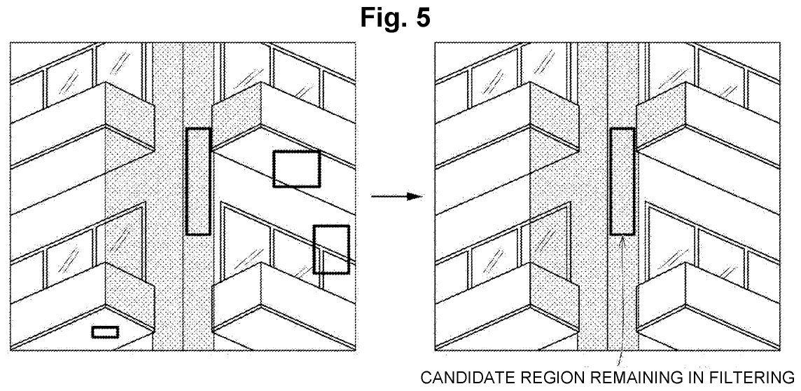

On the other hand, at a detection time, a search region is specified from a plurality of target images using a semi-supervised learning method separately from the discriminator. As semi-supervised learning data, a search region is manually designated for a part of the plurality of target images like a dot region shown in FIG. 3. Since a required number of the target images may be as small as several images, work is possible in a realistic time in actual operation. A designation method is the same as a method of imparting the teacher label of the deterioration region. A semi-supervised learning device automatically imparts, based on the teacher label, position information of the search region to the remaining target images (a dot region on the right side of FIG. 4). Consequently, a search region of input all target images is specified. Filtering of candidate regions output by the discriminator is performed using a mask image designating the specified search region (FIG. 5). A dot region in FIG. 5 indicates the search region and a thick line frame indicates the candidate region. Note that, since only the image for learning segmented such that only the search region is the background is input by the discriminator, a discrimination problem that the discriminator should solve is further simplified and a burden of the learning processing is reduced. As a result, erroneous detection of a deterioration event can be effectively suppressed in conjunction with the filtering of the candidate regions.

Further, in order to increase this suppression effect, preprocessing explained below can be added when a target image is an infrared image. That is, an average value of temperatures of pixels present in a deterioration region of an image for learning is calculated after segmentation of the image for learning and linear conversion of pixel values is carried out in a specific temperature range in which the value is set as a median. The median is, for example, 128 in an 8-bit monochrome image. A pixel value outside a range of the linear conversion is saturated to a maximum value or a minimum value of the specific temperature range. Learning is performed using the image for learning output in that way. At a detection time, the linear conversion is applied while shifting a specific range having the same width as the width at the learning time from a low temperature to a high temperature little by little. Deterioration detection is performed by searching through all of a plurality of target images formed by the linear conversion. Consequently, even a signal having a low S/N ratio is converted into a signal having appropriate amplitude. Therefore, it is possible to more effectively carry out the deterioration detection processing.

### Configuration of a Learning Device According to this Embodiment

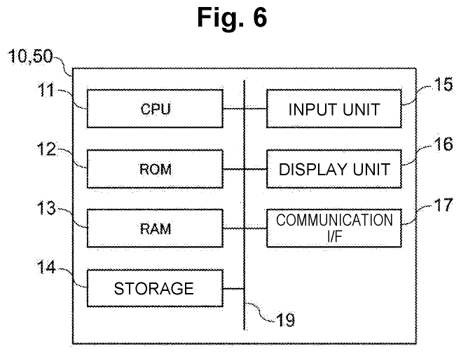

FIG. 6 is a block diagram showing a hardware configuration of a learning device 10 in this embodiment.

As shown in FIG. 6, the learning device 10 includes a CPU (Central Processing Unit) 11, a ROM (Read Only Memory) 12, a RAM (Random Access Memory) 13, a storage 14, an input unit 15, a display unit 16, and a communication interface (I/F) 17. The components are communicably connected to one another via a bus 19.

The CPU 11 is a central arithmetic processing unit and executes various programs and controls the units. That is, the CPU 11 reads out a program from the ROM 12 or the storage 14 and executes the program using the RAM 13 as a work region. The CPU 11 performs control of the components and various arithmetic processing according to the program stored in the ROM 12 or the storage 14. In this embodiment, a learning program for learning a neural network is stored in the ROM 12 or the storage 14. The learning program may be one program or may be a program group configured by a plurality of programs or modules.

The ROM 12 stores various programs and various data. The RAM 13 functions as a work region and temporarily stores a program or data. The storage 14 is configured by an HDD (Hard Disk Drive) or an SSD (Solid State Drive) and stores various programs including an operating system and various data.

The input unit 15 includes a pointing device such as a mouse and a keyboard and is used to perform various inputs.

The input unit 15 receives a plurality of inputs of a set of an image for learning including a deterioration region where a predetermined deterioration event occurs on the surface of a structure and position information of a deterioration region in an image for learning imparted as a teacher label. Note that, in the inputs, an image segmented to include only a search region as a background is set as the image for learning (FIG. 2).

The display unit 16 is, for example, a liquid crystal display and displays various kinds of information. The display unit 16 may adopt a touch panel scheme and function as the input unit 15.

The communication interface 17 is an interface for communicating with other equipment. For example, a standard such as Ethernet (registered trademark), FDDI, or Wi-Fi (registered trademark) is used.

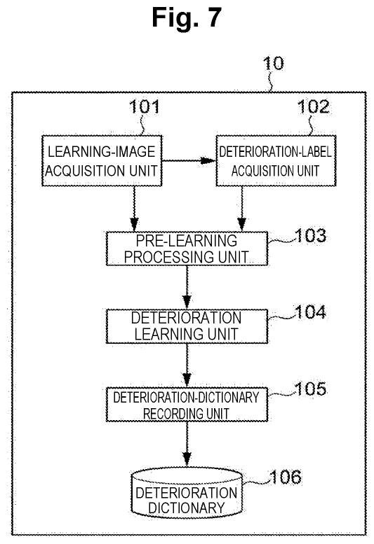

Subsequently, a functional configuration of the learning device 10 is explained. FIG. 7 is a block diagram showing an example of the functional configuration of the learning device 10.

In terms of functions, the learning device 10 includes, as shown in FIG. 7, a learning-image acquisition unit 101, a deterioration-label acquisition unit 102, a pre-learning processing unit 103, a deterioration learning unit 104, a deterioration-dictionary recording unit 105, and a deterioration dictionary 106.

The learning-image acquisition unit 101 acquires a plurality of images for learning received by the input unit 15 and transmits the plurality of images for learning to the deterioration-label acquisition unit 102 and the pre-learning processing unit 103.

The deterioration-label acquisition unit 102 acquires position information of a deterioration region in an image for learning received by the input unit 15 as a teacher label.

Specifically, when the deterioration region is rectangular, the deterioration-label acquisition unit 102 acquires position information represented by four parameters of an upper left position coordinate (x, y) and a rectangle width “width” and a rectangle height “height”. When the deterioration region is input in a free form, the deterioration-label acquisition unit 102 acquires position information represented by a binary image in which pixels corresponding to the deterioration region are 1 and the other pixels are 0.

The pre-learning processing unit 103 converts pixel values of pixels of the image for learning using a conversion function for converting an image value into a pixel value in a specific range.

Specifically, the pre-learning processing unit 103 creates, based on pixel value information in the deterioration region obtained from the image for learning acquired by the learning-image acquisition unit 101 and the position information of the deterioration region acquired by the deterioration-label acquisition unit 102, a conversion function represented by an input and output curve, performs, using the conversion function, pixel value conversion processing for converting pixel values of pixels of the image for learning to adjust contrast, and transmits the image for learning after the conversion to the deterioration learning unit 104.

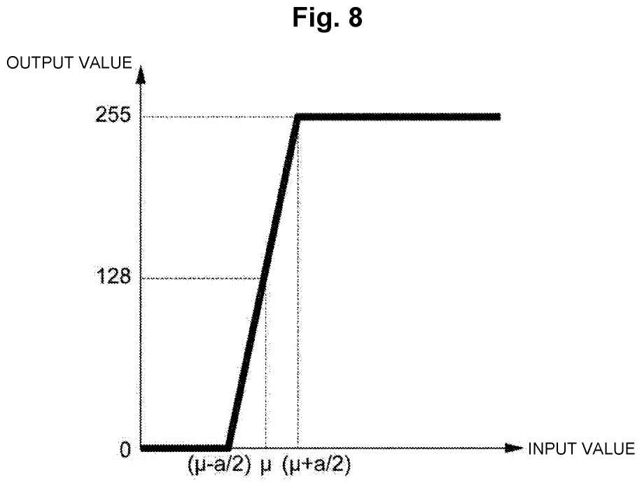

For example, the pre-learning processing unit 103 calculates an average of all pixel values in the deterioration region for the images for learning acquired by the learning-image acquisition unit 101 and linearly converts the pixel values into pixel values in a specific range in which a value of the average is a median. Note that pixel values outside a predetermined range linearly converted into the specific range are saturated to a maximum value or a minimum value in the specific range. Specifically, the pixel values only have to be converted using a conversion function represented by an input and output curve shown in FIG. 8. In FIG. 8, μ represents an average of all the pixel values in the deterioration region and “a” represents width of a predetermined specific range. The image for learning after the conversion is an 8-bit monochrome image. Note that a value of “a” is a value set based on experience of a user as a range sufficiently larger than an amplitude component of a deterioration pattern. However, standard deviations of the pixel values in the deterioration region may be calculated and the value of “a” may be calculated by multiplying, by an appropriate coefficient, a value obtained by averaging the standard deviations in all images.

The deterioration learning unit 104 optimizes, based on the image for learning after the conversion by the pre-learning processing unit 103 and the position information of the deterioration region in the image for learning imparted as the teacher label, from supervised learning, a weight parameter of a discriminator for discriminating the deterioration region.

Specifically, the deterioration learning unit 104 performs machine learning using the image for learning after the conversion by the pre-learning processing unit 103 and the teacher label. The deterioration learning unit 104 carries out the machine learning using a discriminator generally considered as having good performance represented by Mask R-CNN. After the learning, the deterioration learning unit 104 transmits an optimized weight parameter value to the deterioration-dictionary recording unit 105.

The deterioration-dictionary recording unit 105 records, in the deterioration dictionary 106, the weight parameter of the discriminator optimized by the deterioration learning unit 104.

### Configuration of a Target Region Detection Device According to this Embodiment

FIG. 6 is a block diagram showing a hardware configuration of a target region detection device 50 in this embodiment.

As shown in FIG. 6, like the learning device 10, the target-region detection device 50 includes the CPU (Central Processing Unit) 11, the ROM (Read Only Memory) 12, the RAM (Random Access Memory) 13, the storage 14, the input unit 15, the display unit 16, and the communication interface (I/F) 17. In this embodiment, a target region detection program for detecting a deterioration region is stored in the ROM 12 or the storage 14. The target region detection program may be one program or may be a program group configured by a plurality of programs or modules.

The ROM 12 stores various programs and various data. The RAM 13 functions as a work region and temporarily stores a program or data. The storage 14 is configured by an HDD (Hard Disk Drive) or an SSD (Solid State Drive) and stores various programs including an operating system and various data.

The input unit 15 receives, as inputs, a plurality of target images representing the surface of a structure and position information of a search region serving as a teacher label in a part of the target images. Note that, in this embodiment, it is assumed that all of the plurality of target images are photographed in advance and data input of the plurality of target images can be collectively performed. As shown in FIG. 3, position information of a search region is manually input as a teacher label to a part of the plurality of target images input by the input unit 15.

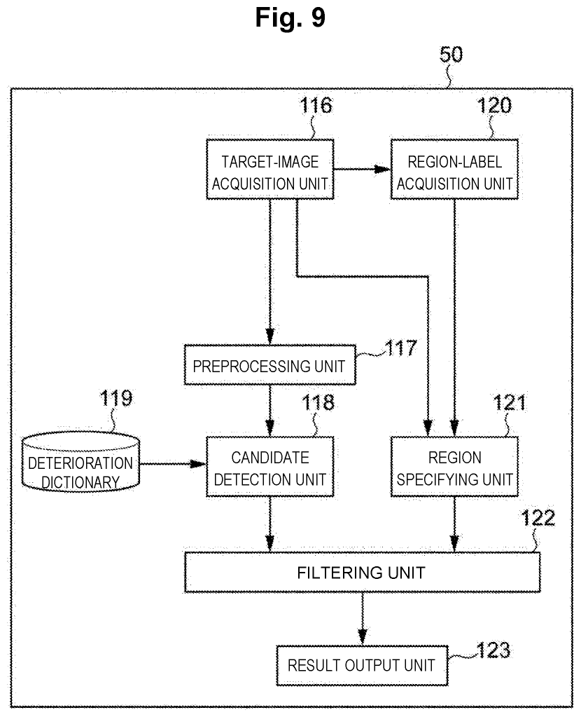

Subsequently, a functional configuration of the target region detection device 50 is explained. FIG. 9 is a block diagram showing an example of the functional configuration of the target region detection device 50.

In terms of functions, the target region detection device 50 includes, as shown in FIG. 9, a target-image acquisition unit 116, a preprocessing unit 117, a candidate detection unit 118, a deterioration dictionary 119, a region-label acquisition unit 120, a region specifying unit 121, a filtering unit 122, and a result output unit 123.

The target-image acquisition unit 116 acquires a plurality of target images received by the input unit 15.

The preprocessing unit 117 converts pixel values of pixels of a target image using a conversion function for converting an image value into a pixel value in a specific range. In this embodiment, the preprocessing unit 117 converts, for each of a plurality of kinds of conversion function respectively different in the specific range, using the conversion function, the pixel value of the pixels of the target image to thereby generate, for one target image, a plurality of contrast-adjusted target images after the conversion and transmits the plurality of target images to the candidate detection unit 118.

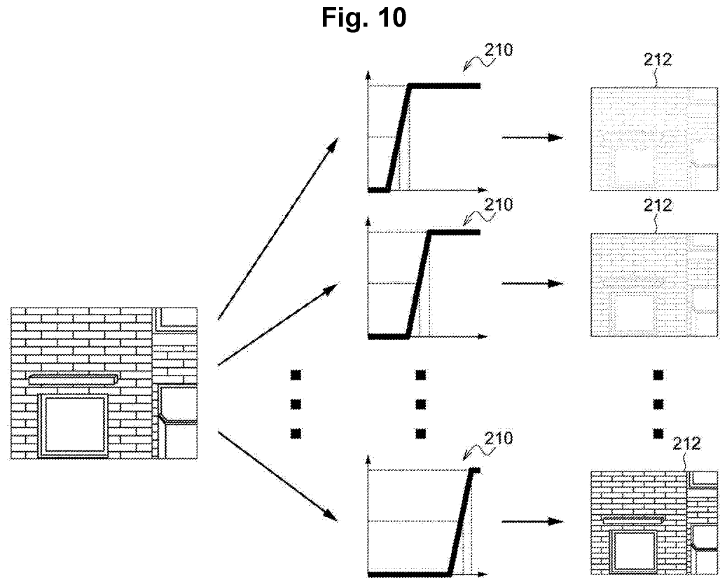

Specifically, the preprocessing unit 117 generates a plurality of target images 212 after conversion using a plurality of kinds of conversion functions 210 in which specific ranges are variously changed as shown in FIG. 10 and transmits all of the images to the candidate detection unit 118. With regard to the specific range, the preprocessing unit 117 uses the value of “a” set by the pre-learning processing unit 103 as it is and, while sliding, with the value fixed, the specific range in a direction in which temperature increases at a fixed rate, outputs a target image after conversion obtained by using a conversion function for converting a pixel value into a pixel value in the specific range. Consequently, it is possible to perform appropriate contrast adjustment without breaking a signal indicating deterioration in both a high part and a low part of a background temperature.

The candidate detection unit 118 detects, for each of the acquired plurality of target images, from each of target images after conversion obtained from the target image, candidate regions representing a deterioration region using a discriminator learned in advance by the learning device 10. The candidate detection unit 118 integrates, with an OR operation, the candidate regions detected from each of the target images after the conversion obtained from the target image, sets the candidate regions as candidate regions in the target image, and transmits the candidate regions to the filtering unit 122.

The deterioration dictionary 119 stores the same weight parameter of the discriminator as the weight parameter stored by the deterioration dictionary 106 of the learning device 10.

The region-label acquisition unit 120 acquires position information of a search region in a part of the acquired plurality of target images, the position information being received as a teacher label by the input unit 15 for the target image, and transmits the position information to the region specifying unit 121.

The region specifying unit 121 imparts, based on the part of the target images for which the teacher label is received and the position information of the search region acquired as the teacher label, the position information of the search region to each of the target images, which are not the part of the acquired plurality of target images, in semi-supervised learning processing.

Specifically, the region specifying unit 121 specifies a search region from each of the plurality of target images using the semi-supervised learning method. The region specifying unit 121 automatically imparts, according to the semi-supervised learning processing using the teacher label transmitted from the region-label acquisition unit 120, position information of the search region to each of the remaining target images for which the teacher label is not received. As the semi-supervised learning method, for example, a method described in Non-Patent Literature 1 can be used. However, various methods known in the past can be used.

Non-Patent Literature 1: Hoffer, Ailon, “Semi-supervised deep learning by metric embedding” ICLR Workshop, 2017

Consequently, the search region is specified for all of the target images input by the target-image acquisition unit 116 (FIG. 4). The region specifying unit 121 separately generates a mask image representing the specified search region and transmits the mask image to the filtering unit 111.

The filtering unit 122 performs, for each of the acquired plurality of target images, filtering processing for outputting a candidate region, an overlapping degree of which with the search region is equal to or larger than a fixed threshold, among the candidate regions of the target image detected by the candidate detection unit 118.

Specifically, the filtering unit 122 calculates, for each of the candidate regions detected by the candidate detection unit 118, as a rate, an overlapping degree representing to which degree the search region specified by the region specifying unit 121 overlaps each of the candidate regions detected by the candidate detection unit 118 and, if a value of the overlapping degree is larger than a predetermined threshold, specifies the candidate region as a “deterioration region” and outputs the candidate region. Specifically, the filtering unit 122 calculates an overlapping degree C. based on the following expression.

$$\begin{matrix}[ Math . 1 ] & \\ C = \frac{{\sum }_{i , j} \{ {S}_{detect} ( i , j ) \times {S}_{search} ( i , j ) \}}{{\sum }_{i , j} {S}_{detect} ( i , j )} & ( 1 )\end{matrix}$$

In the expression, as S_{detect}(i,j), for one candidate region, in a pixel (i,j) in the candidate region, S_{detect}(i,j)=1, and, in a pixel (i,j) outside the candidate region, S_{detect}(i,j)=0. As S_{search}(i,j), in the pixel (i,j) in the search region, S_search(i,j)=1 and, in the pixel (i,j) outside the search region, S_{search}(i,j)=0. Information concerning the specified deterioration region is transmitted to a result output unit 112.

The result output unit 123 outputs the deterioration region specified by the filtering unit 122 to the display unit 16. Specifically, the result output unit 112 outputs the deterioration region as an image indicating a region specified as the deterioration region or rectangular position data indicating the position of the region to a display. Alternatively, the result output unit 123 may output the deterioration region specified by the filtering unit 122 to a recording medium such as an HDD.

### Action of the Learning Device According to this Embodiment

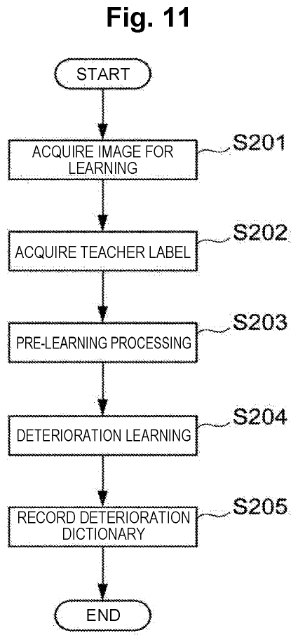

Subsequently, action of the learning device 10 is explained. FIG. 11 is a flowchart showing a flow of learning processing by the learning device 10. The CPU 11 reads out the learning program from the ROM 12 or the storage 14, loads the learning program in the RAM 13, and executes the learning program, whereby the learning processing is performed. A plurality of sets of an image for learning representing a deterioration region where a predetermined deterioration event occurs on the surface of a structure and position information of the deterioration region in the image for learning given as a teacher label are input to the learning device 10.

In step S201, the CPU 11 functions as the learning-image acquisition unit 101, acquires a plurality of images for learning including the deterioration region where the predetermined deterioration event occurs on the surface of the structure received by the input unit 15, and transmits the plurality of images for learning to the deterioration-label acquisition unit 102 and the pre-learning processing unit 103.

In step S202, the CPU 11 functions as the deterioration-label acquisition unit 102 and acquires position information of a deterioration region in a plurality of images for learning received by the input unit 15 as a teacher label.

In step S203, the CPU 11 functions as the pre-learning processing unit 103 and calculates, based on pixel value information of the deterioration region in the plurality of images for learning, a conversion function for converting an image value into a pixel value is a specific range. The CPU 11 converts pixel values of pixels of the plurality of images for learning using the calculated conversion function.

In step S204, the CPU 11 functions as the deterioration learning unit 104 and optimizes, based on the plurality of images for learning after the conversion by the pre-learning processing unit 103 and the position information of the deterioration region in the plurality of images for learning imparted as a teacher label, from supervised learning, a weight parameter of a discriminator for discriminating the deterioration region.

In step S205, the CPU 11 functions as the deterioration-dictionary recording unit 105 and records, in the deterioration dictionary 106, the weight parameter of the discriminator optimized by the deterioration learning unit 104.

### Action of the Target Region Detection Device According to this Embodiment

Subsequently, action of the target region detection device 50 according to this embodiment is explained.

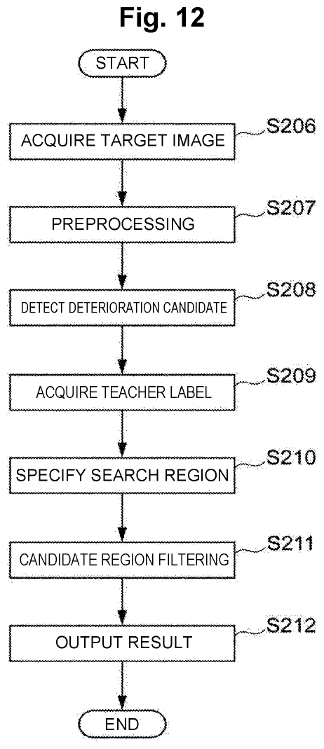

FIG. 12 is a flowchart showing a flow of target region detection processing by the target region detection device 50. The CPU 11 reads out the target region detection program from the ROM 12 or the storage 14, loads the target region detection program in the RAM 13, and executes the target region detection program, whereby the target region detection processing is performed. A plurality of target images representing the surface of a structure are input to the target region detection device 50.

In step S206, the CPU 11 functions as the target-image acquisition unit 116 and acquires a plurality of target images received by the input unit 15.

In step S207, the CPU 11 functions as the preprocessing unit 117 and converts, for each of the target images, for each of a plurality of kinds of conversion functions respectively different in the specific range, pixel values of pixels of the target image using the conversion function. The CPU 11 generates, for each of the target images, a plurality of contrast-adjusted target images after the conversion and transmits the plurality of target images to the candidate detection unit 118.

In step S208, the CPU 11 functions as the candidate detection unit 118 and detects, for each of the acquired plurality of target images, from each of the target images after the conversion obtained from the target image, candidate regions representing a deterioration region using a discriminator learned in advance by the learning device 10. The CPU 11 integrates, with an OR operation, the candidate regions detected from each of the target images after the conversion obtained from the target image and transmits the candidate regions to the filtering unit 122 as a candidate region in the target image.

In step S209, the CPU 11 functions as the region-label acquisition unit 120, acquires position information of a search region in a part of the acquired plurality of target images received as a teacher label by the input unit 15 for the target image and transmits the position information to the region specifying unit 121.

In step S210, the CPU 11 functions as the region specifying unit 121 and imparts, based on the part of the target images for which the teacher label is received and the position information of the search region acquired as the teacher label, the position information of the search region to each of the target images, which are not the part of the acquired plurality of target images, in the semi-supervised learning processing to specify the search region.

In step S211, the CPU 11 functions as the filtering unit 122 and performs, for each of the acquired plurality of target images, filtering processing for outputting a candidate region, an overlapping degree of which with the search region is equal to or larger than a fixed threshold, among the candidate regions of the target image detected by the candidate detection unit 118.

In step S212, the CPU 11 functions as the result output unit 123 and outputs the deterioration region specified by the filtering unit 122 to the display unit 16.

As explained above, the target region detection device according to this embodiment detects, using the discriminator, candidate regions representing a deterioration region from a plurality of target images and acquires, for a part of the plurality of target images, position information of a search region in the target image as a teacher label. The target region detection device imparts, based on the part of the target images and the acquired position information of the search region, the position information of the search region to each of the target images, which are not the part of the target images, in the semi-supervised learning processing. The target region detection device outputs, for each of the acquired plurality of target images, from the detected candidate regions, a candidate region, an overlapping degree of which with the search region is equal to or larger than a fixed threshold. Consequently, it is possible to detect the deterioration region from the plurality of target images with simple processing.

It is possible to accurately automatically extract, from various camera images, a deterioration region representing a deterioration event having an apparently weaker signal than other noise present in the background and having an extremely various shape patterns represented by “loose scale”.

Note that the present invention is not limited to the device configuration and the action of the embodiment explained above. Various modifications and applications are possible within a range not departing from the gist of the present invention.

For example, in the learning device, a case in which an image is manually segmented and an image for learning is input is described as an example. However, not only this, but an algorithm for automatically calculating a search region using the method carried out by the region specifying unit 121 and segmenting an image as a rectangle inscribing the search region may be implemented to automate image segmentation work. This is more excellent in that a part of manually performed image segmentation work in a learning process can be reduced.

Even when there are a plurality of kinds of deterioration events desired to be detected, it is possible to cope with the plurality of kinds of deterioration events by individually configuring discriminators for the respective deterioration events or configuring a multi-class discriminator.

A case in which the learning device and the target region detection device are separately configured is explained as an example. However, not only this, but the learning device and the target region detection device may be configured as one device.

A case in which the detection target region is the deterioration region where the predetermined deterioration event occurs on the surface of the structure is explained as an example. However, not only this, but a region where an event other than the deterioration event occurs may be set as the detection target region.

Various processors other than the CPU may execute the various kinds of processing executed by the CPU reading software (the programs) in the embodiment. Examples of the processors in this case include a PLD (Programmable Logic Device) capable of changing a circuit configuration after manufacturing such as an FPGA (Field-Programmable Gate Array) and a dedicated electric circuit, which is a processor having a circuit configuration exclusively designed in order to execute specific processing such as an ASIC (Application Specific Integrated Circuit). The learning processing and the target region detection processing may be executed by one of these various processors or may be executed by a combination of two or more processors of the same type or different types (for example, a plurality of FPGAs and a combination of the CPU and the FPGA). A hardware structure of the various processors is more specifically an electric circuit obtained by combining circuit elements such as semiconductor elements.

In the embodiments, a form in which the learning program and the target region detection program are stored (installed) in advance in the storage 14 is explained. However, not only this, but the programs may be provided in a form in which the programs are stored in non-transitory storage media such as a CD-ROM (Compact Disk Read Only Memory), a DVD-ROM (Digital Versatile Disk Read Only Memory), and a USB (Universal Serial Bus) memory. The programs may be downloaded from an external device via a network.

Concerning the embodiment explained above, the following supplementary notes are further disclosed.

### Supplementary Note 1

a target region detection device including:

a memory; and

at least one processor connected to the memory, the processor:

acquiring a plurality of target images set as targets for detecting a specific detection target region;

detecting, for each of the acquired plurality of target images, from the target image, candidate regions representing the specific detection target region using a pre-learned discriminator for discriminating the specific detection target region;

acquiring, for a part of the acquired plurality of target images, position information of a search region in the target image as a teacher label;

imparting, based on the part of the target images and the acquired position information of the search region, the position information of the search region to each of the target images, which are not the part of the target images, among the acquired plurality of target images in semi-supervised learning processing; and

performing, for each of the acquired plurality of target images, filtering processing for outputting, from the detected candidate regions, a candidate region, an overlapping degree of which with the search region is equal to or larger than a fixed threshold.

### Supplementary Note 2

A non-transitory storage medium storing a program executable by a computer to execute target region detection processing,

the target region detection processing:

acquiring a plurality of target images set as targets for detecting a specific detection target region;

detecting, for each of the acquired plurality of target images, from the target image, candidate regions representing the specific detection target region using a pre-learned discriminator for discriminating the specific detection target region;

acquiring, for a part of the acquired plurality of target images, position information of a search region in the target image as a teacher label;

imparting, based on the part of the target images and the acquired position information of the search region, the position information of the search region to each of the target images, which are not the part of the target images, among the acquired plurality of target images in semi-supervised learning processing; and

performing, for each of the acquired plurality of target images, filtering processing for outputting, from the detected candidate regions, a candidate region, an overlapping degree of which with the search region is equal to or larger than a fixed threshold.

### REFERENCE SIGNS LIST

10 Learning device

15 Input unit

16 Display unit

50 Target region detection device

101 Learning-image acquisition unit

102 Deterioration-label acquisition unit

103 Pre-learning processing unit

104 Deterioration learning unit

105 Deterioration-dictionary recording unit

106 Deterioration dictionary

111 Filtering unit

112 Result output unit

116 Target-image acquisition unit

117 Preprocessing unit

118 Candidate detection unit

119 Deterioration dictionary

120 Region-label acquisition unit

121 Region specifying unit

122 Filtering unit

123 Result output unit

1. A target region detection device comprising a processor configured to execute a method comprising:
acquiring a plurality of target images set as targets for detecting a specific detection target region;
detecting, for each of the acquired plurality of target images, from a target image, candidate regions representing the specific detection target region based on discriminating the specific detection target region according to a pre-learning;
acquiring, for a part of the acquired plurality of target images, position information of a search region in the target image as a teacher label;
imparting, based on the part of the acquired plurality of target images and the position information of the search region the position information of the search region to each of the acquired plurality of target images, which are not the part of the acquired plurality of target images, among the acquired plurality of target images in semi-supervised learning processing; and
performing, for each of the acquired plurality of target images, filtering processing for outputting, from the candidate regions a candidate region, an overlapping degree of which with the search region is equal to or larger than a fixed threshold.

2. The target region detection device according to claim 1, the processor further configured to execute a method comprising:
converting pixel values of pixels of the target image using a conversion function for converting an image value into a pixel value in a specific range, wherein
the detecting further comprises detecting, for each of the plurality of target images, the candidate region from the target image by the discriminating according to the pre-learning.

3. The target region detection device according to claim 2, the processor further configured to execute a method comprising:
converting, for each of a plurality of kinds of the conversion functions respectively different in the specific range, the pixel values of the pixels of the target image using the conversion function;
detecting the candidate regions by discriminating from each of the acquired plurality of target images converted using each of the plurality of kinds of the conversion functions; and
integrating the detected candidate regions.

4. The target region detection device according to claim 1, wherein the discriminating further comprises learning in advance based on an image for learning including the specific detection target region and position information of the specific detection target region in the image for learning imparted as a teacher label.

5. The target region detection device according to claim 1 wherein the specific detection target region includes a deterioration region representing a predetermined deterioration event on a surface of a structure.

6. A target region detection method comprising:
acquiring a plurality of target images set as targets for detecting a specific detection target region;
detecting, for each of the acquired plurality of target images, from a target image, candidate regions representing the specific detection target region by discriminating the specific detection target region according to pre-learning;
acquiring, for a part of the acquired plurality of target images, position information of a search region in the target image as a teacher label;
imparting, based on the part of the acquired plurality of target images and the position information of the search region, the position information of the search region to each of the acquired plurality of target images, which are not the part of the acquired plurality of target images, among the acquired plurality of target images in semi-supervised learning processing; and
performing, for each of the acquired plurality of target images, filtering processing for outputting, from the candidate regions, a candidate region, an overlapping degree of which with the search region is equal to or larger than a fixed threshold.

7. A computer-readable non-transitory recording medium storing computer-executable target region detection program instructions that when executed by a processor cause a computer to execute a method comprising:
acquiring a plurality of target images set as targets for detecting a specific detection target region;
detecting, for each of the acquired plurality of target images, from a target image, candidate regions representing the specific detection target region by discriminating the specific detection target region according to pre-learning;
acquiring, for a part of the acquired plurality of target images, position information of a search region in the target image as a teacher label;
imparting, based on the part of the acquired plurality of target images and the acquired position information of the search region, the position information of the search region to each of the acquired plurality of target images, which are not the part of the acquired plurality of target images, among the acquired plurality of target images in semi-supervised learning processing; and
performing, for each of the acquired plurality of target images, filtering processing for outputting, from the detected candidate regions, a candidate region, an overlapping degree of which with the search region is equal to or larger than a fixed threshold.

8. The target region detection device according to claim 2, wherein the discriminating further comprises learning in advance based on an image for learning including the specific detection target region and position information of the specific detection target region in the image for learning imparted as a teacher label.

9. The target region detection device according to claim 2, wherein the specific detection target region includes a deterioration region representing a predetermined deterioration event on a surface of a structure.

10. The target region detection method according to claim 6, the method further comprising:
converting pixel values of pixels of the target image using a conversion function for converting an image value into a pixel value in a specific range, wherein
the detecting further comprises detecting, for each of the acquired plurality of target images, the candidate region from the target image by the discriminating according to the pre-learning.

11. The target region detection method according to claim 10, further comprising:
converting, for each of a plurality of kinds of the conversion functions respectively different in the specific range, the pixel values of the pixels of the target image using the conversion function;
detecting the candidate regions by discriminating from each of the acquired plurality of target images converted using each of the plurality of kinds of the conversion functions; and
integrating the detected candidate regions.

12. The target region detection method according to claim 6, wherein the discriminating further comprises learning in advance based on an image for learning including the specific detection target region and position information of the specific detection target region in the image for learning imparted as a teacher label.

13. The target region detection method according to claim 6, wherein the specific detection target region includes a deterioration region representing a predetermined deterioration event on a surface of a structure.

14. The target region detection method according to claim 10, wherein the discriminating further comprises learning in advance based on an image for learning including the specific detection target region and position information of the specific detection target region in the image for learning imparted as a teacher label.

15. The target region detection method according to claim 10, wherein the specific detection target region includes a deterioration region representing a predetermined deterioration event on a surface of a structure.

16. The computer-readable non-transitory recording medium according to claim 7, the computer-executable target region detection program instructions when executed further cause a computer to execute a method comprising:
converting pixel values of pixels of the target image using a conversion function for converting an image value into a pixel value in a specific range, wherein
the detecting further comprises detecting, for each of the acquired plurality of target images, the candidate region from the target image by the discriminating according to the pre-learning.

17. The computer-readable non-transitory recording medium according to claim 16, the computer-executable target region detection program instructions when executed further cause a computer to execute a method comprising:
converting, for each of a plurality of kinds of the conversion functions respectively different in the specific range, the pixel values of the pixels of the target image using the conversion function;
detecting the candidate regions by discriminating from each of the acquired plurality of target images converted using each of the plurality of kinds of the conversion functions; and
integrating the detected candidate regions.

18. The computer-readable non-transitory recording medium according to claim 7, wherein the discriminating further comprises learning in advance based on an image for learning including the specific detection target region and position information of the specific detection target region in the image for learning imparted as a teacher label.

19. The computer-readable non-transitory recording medium according to claim 7, wherein the specific detection target region includes a deterioration region representing a predetermined deterioration event on a surface of a structure.

20. The computer-readable non-transitory recording medium according to claim 16, wherein the discriminating further comprises learning in advance based on an image for learning including the specific detection target region and position information of the specific detection target region in the image for learning imparted as a teacher label.
